(19) United States
(12) Patent Application Publication
(10) Pub. No.: US 2001/0019082 A1
(43) Pub. Date: Sep. 6, 2001

(54) Spraying apparatus for crops having unusually high trees

(76) Inventor: Shiro Nishimura, Pompeia (BR)

Correspondence Address: Striker, Striker & Stenby, 103 East Neck Road, Huntington, NY, 11743, US

(21) Appl. No.: 09/784,263

(22) Filed: Feb. 15, 2001

(30) Foreign Application Priority Data
Feb. 18, 2000 (BR) PI-0000943-1

(51) Int. Cl. B05B 9/06; A62C 31/24; B05B 1/20

(52) U.S. Cl. 239/77; 239/78; 239/280; 239/280.5; 239/281; 239/159; 239/164

(57) ABSTRACT

A spraying apparatus for crops having unusually high trees, the spraying apparatus comprising means for producing a vertical flow of air with an agrochemical product, an air conduit having an inlet connected to a discharge of the flow producing means and also having an outlet, spraying means for producing a mist from the air flow with the agricultural product and spraying the mist to a tree, the air conduit being flexible and bellows-shaped, and means for extending and retracting the air conduit so that the air conduit can be extended and retracted according to a height of the tree and to position the spraying means at a corresponding height for spraying the mist to a desired target.

### BACKGROUND OF THE INVENTION

The present invention relates to agricultural equipment, and more particularly to a spraying apparatus particularly designed for effective spraying of agrochemical products in crops of fruits having unusually high trees, such as dates, coconuts, pecans, rubber trees, papaya and the like.

It is well known that in order to effective protect the fruit trees in the field against diseases and infestation of plagues, the trees in the crop are positioned in rows and a spraying apparatus is towed by a tractor in the alleys between the rows of trees to spray a solution of an agricultural chemical suitable to fight the specific plague on one or both sides of the trees. The solution is usually sprayed in the form of a mist through spraying nozzles mounted on the apparatus. A reservoir is used to store the solution of the agricultural chemical to be sprayed at the trees through the mist spraying nozzles.

Since the trees are unusually high, the mist spray of the agricultural chemical has to be sprayed by a strong, uniform stream of air with a long reach, in order to spray the target. Thereby some of the spraying apparatuses are provided with a radial fan having a conduit for directing the flow of air coupled at its discharge end, in order to direct the air generated by the fan upwardly. These spraying apparatuses are formed so that the flow of air is directed to the upper part of the tree, where generally the fruits grow. The mist generated nozzles are positioned at the upper discharge end of the air conduit, so that the flow of air carries the mist spray of the agricultural chemical to the desired target.

This approach however has some problems. In some cases the height of the trees to be sprayed can reach over 20 meters. Typically, most of the spraying apparatuses for spraying agricultural chemicals have the fan and the conduit position close to the ground, and therefore not capable of directing the flow of air to the upper part of the trees. Also, the flow of air reaches the tree the chemical is dispersed, whereby the environmental pollution caused by the agricultural chemical increases considerably.

Another disadvantage of the known spraying apparatuses is that, due to the fixed construction of the air conduit they can not maintain a uniform and effective spraying operation with trees having different heights.

### SUMMARY OF THE INVENTION

Accordingly, it is an object of present invention to provide a spraying apparatus for crops which is designed to effectively spray an agrochemical product in crops of fruits having unusually high trees such as dates, coconuts, pecans, rubber trees, papaya and the like.

It is another object of the present invention to provide such a spraying apparatus which allows an effective spraying of agrochemical products in crops of fruits having unusually high trees which is designed so that an effective spraying of the upper part of the trees can be performed with the mist of the agrochemical product deposited on the target, so as to minimize the consumption of the products and significantly reduce the contamination of the environment by the product.

It is a further object of the present invention to provide a spraying apparatus which is formed so that it effectively sprays agrochemical products in crops of fruits having unusually high trees with different heights and ages.

In keeping with these objects and with others which will become apparent hereinafter, one feature of present invention resides, briefly stated, in a spraying apparatus which includes:

Claim 1:

A spraying apparatus for crops having unusually high trees, the spraying apparatus comprising means for producing a vertical flow of air with an agrochemical product; an air conduit having an inlet connected to a discharge of said flow producing means and also having an outlet; spraying means for producing a mist from the airflow with the agricultural product and spraying the mis to a tree, said air conduit being flexible and bellows-shaped; and means for extending and retracting said air conduit so that said air conduit can be extended and retracted according to a height of the tree and to position said spraying means at a corresponding height for spraying the mist to a desired target.

When the spraying apparatus is designed in accordance with the present invention, it effectively sprays an agrochemical product in crops of fruits having unusually high trees, so that the spraying is concentrated on the upper part of the trees, including the trees having different heights and ages.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is an elevation side view of a spraying apparatus in accordance with the present invention with an air conduit in a first, totally retracted position;

FIG. 2 is an opposite elevation side view of the spraying apparatus in accordance with the present invention with the conduit in a second, totally extended position;

FIG. 3 is a perspective view, partially sectioned of an upper end of the air conduit provided with deflecting means coupled to it;

FIG. 4 is an elevation upper plan view of a lifting mechanism of the air conduit of the inventive spraying apparatus in the totally retracted position;

FIG. 5 is an elevation front view of the lifting mechanism of the air conduit of the inventive spraying apparatus, in the totally extended position;

FIG. 6 is an elevation side view of the lifting mechanism of the air conduit of the inventive spraying apparatus, showing how it interacts with a pulley system;

FIG. 7 is an upper plan view showing an arrangement of guide tubes of the air conduit of the inventive spraying apparatus;

FIGS. 8 and 9 are perspective views showing other arrangements of a baffel for use with the inventive spraying apparatus; and

FIG. 10 is a view showing a perspective view of an axial fan of the inventive spraying apparatus.

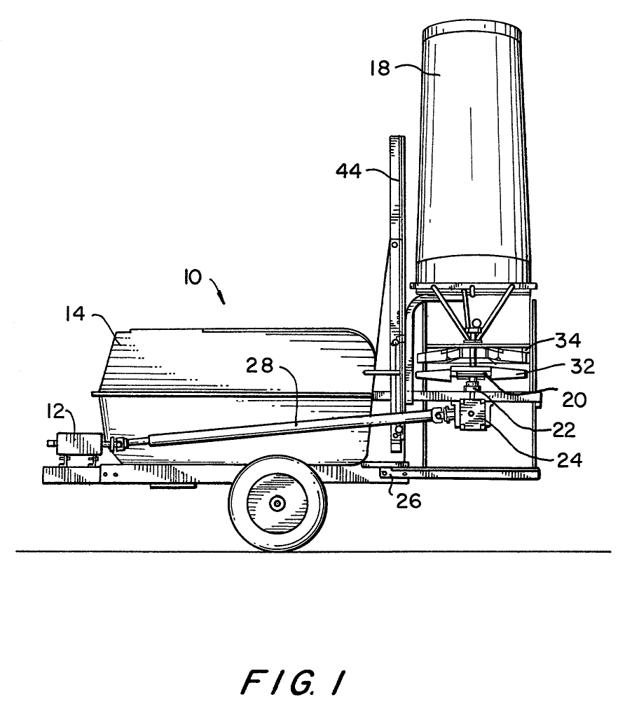

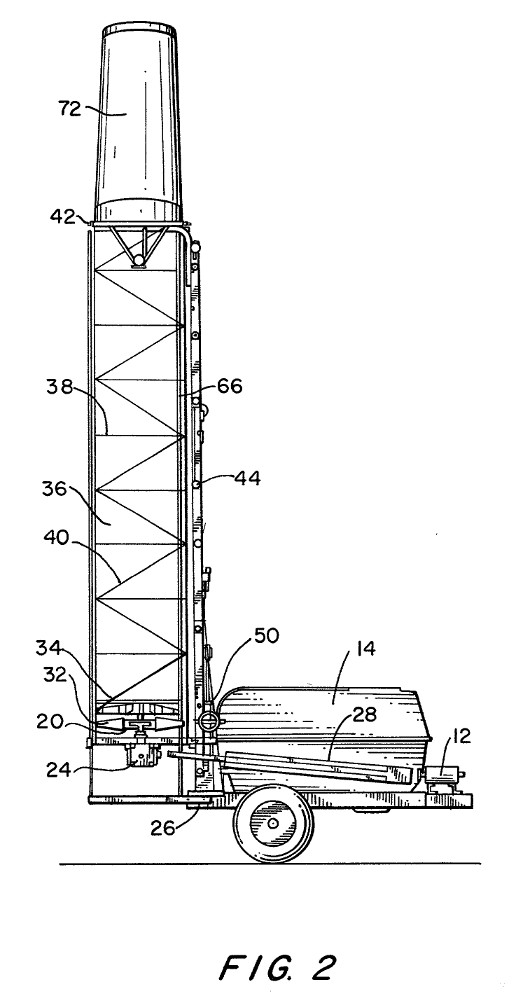

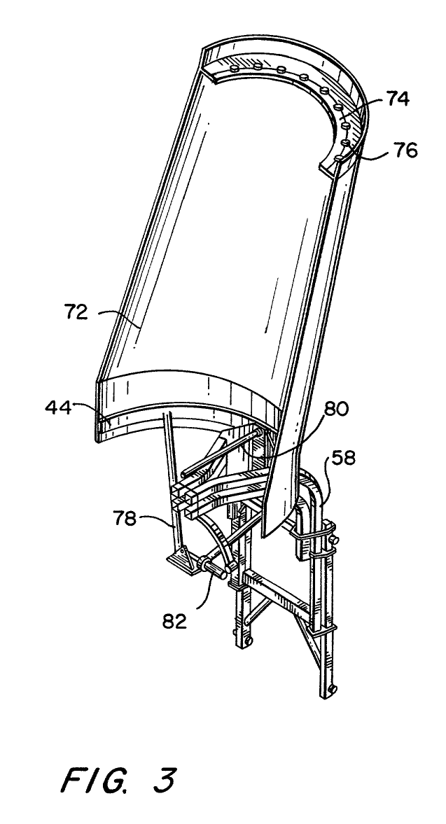

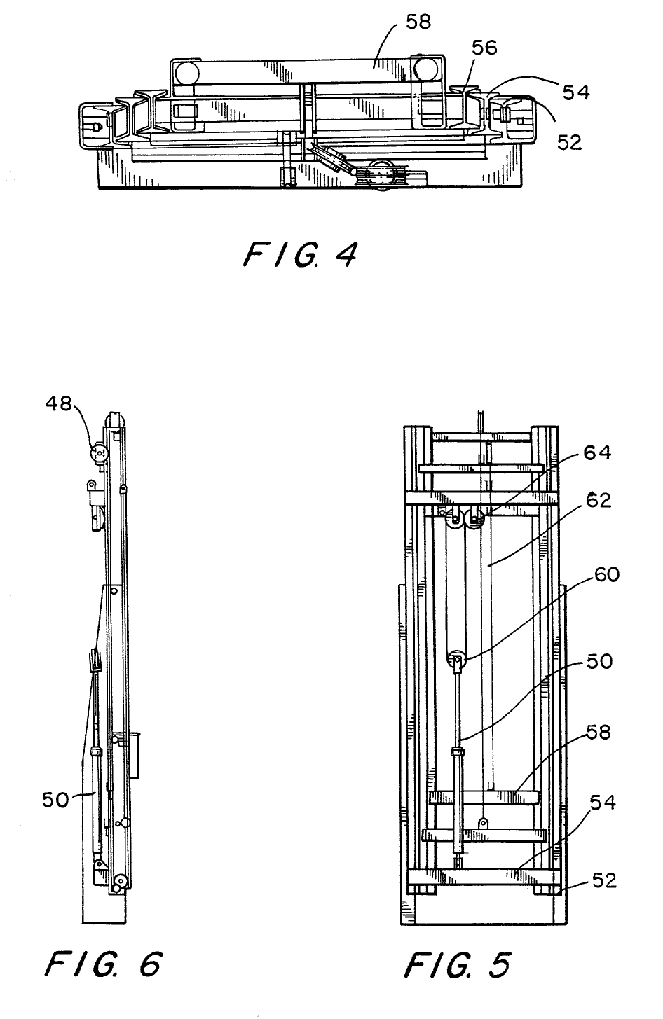

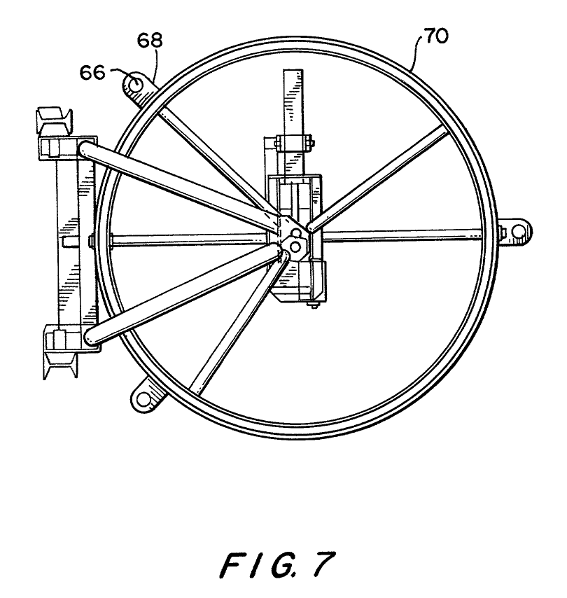

### DESCRIPTION OF PREFERRED EMBODIMENTS

A spraying apparatus in accordance with the present invention is designed for an efficient spraying of agrochemical products in crops of fruits having unusually high trees. The spraying apparatus includes a device which has a conventional atomizer 10 with a pump 12 to pump a solution of agrochemical products stored in a reservoir 14 to not shown valve means that distributes the solution to a spraying system through hoses.

The spraying mechanism includes an axial fan 20 with a shaft 22 positioned in a vertical direction. The fan 20 is driven for example by hydraulic motor or by a gear box 24 coupled to a mounting structure 26 of the chassis. A driving shaft 28 is connected to a power supply of the tractor to drive the gear box 24.

A set of fins is mounted on the mounting structure 26 with the fan 20 located immediately on top of the blades 32. The purpose of the set of fins is to eliminate a spinning tendency of the flow of air generated by the axial fan 20, so as to regulate the air flow and to significantly enhance the reach of the airflow.

The apparatus further has an air conduit 36 which is formed so as to be extended and retracted in accordance with the height of trees. The air conduit 36 is formed as a flexible and bellows-like conduit. It is coupled to a discharge of the mounting structure which contains the axial fan 20 and the set of the fins 34. The air conduit is used to conduct the flow of air generated by the fan. The air conduit 36 is composed of special fabric, for example a silicon-coated polyester fabric. Therefore the fabric has an extremely low weight which allows forming the conduit which can be extended very high.

The air conduit 36 has a plurality of circular steel belted rings 38 which are sown along its length. Also, elastic means 40 are sown over the rings so as to form a bellows-shaped structure which facilitates unfolding and retraction of the air conduit 36. The elastic means can be formed for example as elastic strips, elastic laces, etc.

The air flow generated in the axial fan 20 passes through the set of fins 36 and along the air conduit 36. The air conduit can extend or retract according to the height of the three. The elastic means 40 sown of the circular ring 38 along the length of the conduit provide a required strength to the conduit when it is extended in the vertical direction.

The upper end 42 of the air conduit 46 is coupled with a lifting mechanism 40 which has several stages. The conduit allows the spraying apparatus to be positioned as close as possible to the target. The lifting mechanism 44 includes a plurality of frames which are positioned within each other similarly to a telescopic mechanism and also a pulley system 48 mounted on each frame. A hydraulic cylinder 50 having a very short displacement can lift the end of the lifting mechanism 44 to a great height, through the multiplication provided by the pulley system 48.

With the lower part of the conduit 36 mounted to the mounting structural of the fan 20 the upper end of the air conduit 36 is moved vertically by a lifting mechanism 44. The lifting mechanism has four stages, including a first stage 52 fixed to the mounting structure 26, and three other movable stages 54, 56, 58 which provides positioning of the spraying apparatus next to its target. The stage 52, 54, 56 and 58 are positioned within each other in a telescopic arrangement. When the set of frames is displaced over the guide length of the outer frame 52, at the end of its displacement the frame 54 follows immediately below it, and each stage acts as a guide to the other frames, until the last frame 58 is displaced along the guide formed by the previous frame 56.

The telescopic lifting mechanism 44 is driven by the hydraulic cylinder 50 having a pulley 60 mounted at its upper end. A steel wire 62 runs over the pulley 60, and also over the other pulleys 64 attached to the frames.

At least three vertical tubular guide means 66 are arranged around the air conduit 36. The tubular guide means are also telescopicably mounted around each other to prevent the air conduit 36 from being deformed by the air flow when it is used to spray at intermediate heights. The tubular guide means 66 include concentrically mounted round tubes which are mounted on the mounting structure 26 of the axial fan 20 and positioned around its diameter spaced apart by approximately 120°. They are guided by rings 68 fixed to the circular belted steel rings 38 positioned along the length of the air conduit 36. An upper end of the inner tube of the guide means 68 is fixed to the steel ring 68 which is sown to the highest part to the air conduit 36 so that a vertical displacement of the lifting mechanism causes a guide means to extend and pull the air conduit 36.

The spraying apparatus has an additional accessory for directing and/or distributing the airflow, formed as a baffle 72. The baffle 72 is composed for example of a rigid plastic material, such as polyethylene, it directs, accelerates, and/or distributes the flow of air generated by the fan to the desired target, such as trees, leaves, fruits and others.

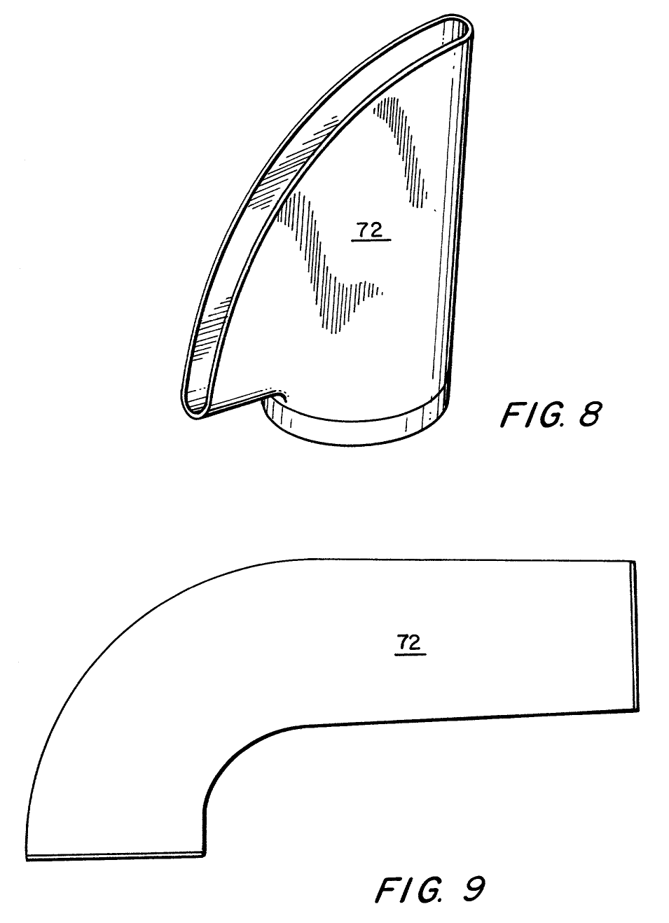

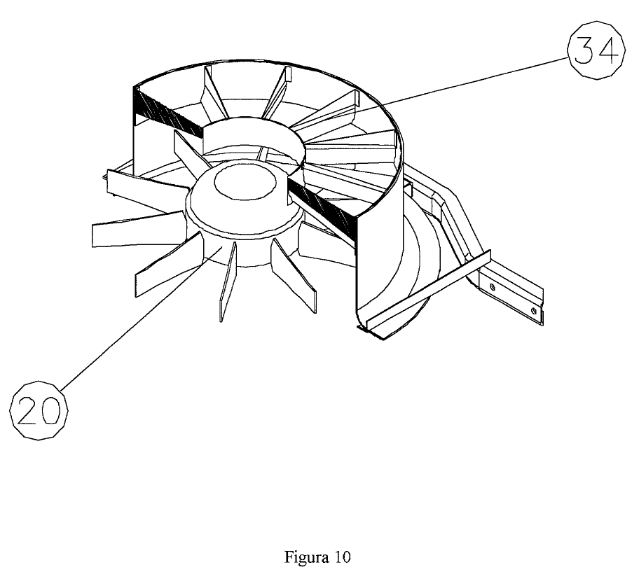

As shown in FIGS. 8 and 9, the baffle can have different shapes according to the type of crop to be sprayed. For example, for palm trees that have its foliage concentrated at its upper end, the ideal baffle would be one having the shape of a mouth, or in other words as cylinder with a diameter of the discharge end smaller than a diameter of its entrance, in order to precisely reach the target. For pecans in which the formation of leaves is more distributed along the tree, the ideal baffle would be elongated, having a circular entrance and a discharge with an oblong shape in order to distribute the air along its length.

An element 74 provided with mist spraying nozzles 76 for spraying is arranged at the discharge end of the baffle 72. The airflow generated by the fan moves along the air conduit 36 and the baffle 72, and at its discharge end directs all the missed spray generated by the nozzles 76 to the desired target.

The assembly formed by the baffle 72 and the element 74 has a base 78 which is supported over the upper stage 58 of the lifting mechanism 44 through a shaft 80 connected to the stage. A hydraulic cylinder 82 is also connected to the upper stage and has a piston shaft connected to the base 78 of the baffle. When the shaft is displaced, the assembly including the baffle 72 and the element 74 is turned by a predetermined angle around the shaft 80, to position it relative to the tree. This mechanism can be optionally controlled by suitable control means, such as sensors, for example ultrasonic sensors, in order to automatically position the spraying apparatus relative to each tree.

The spraying apparatus designed in accordance with the present invention has a great advantage since the height of the air conduit 36 is adjustable to allow the mist spray to be conducted and positioned next to its desired target. The positioning of the discharge of the airflow and of the mist spray next to its target provides substantial reduction of the use of chemicals by reducing the losses to the environment. Without this close and accurate positioning, the spraying would not be as effective as it is with the inventive apparatus, and in some cases even impossible to accomplish.

Another advantage of the spraying apparatus of the present invention is that the air conduit composed of a special fabric and having a bellows-shaped construction allows the discharge of the air flow to be at different heights and accordingly an ideal position for each type or age of the trees. The axial fan having its shaft in a vertical position prevents the flow of air from having to handle turns, and therefore, lose its intensity, so that it provides a continuous and even flow of air at the discharge of the baffle.

The assembly is coupled to a vehicle with the reservoir, pumping system, and other required devices and accessories used with spraying apparatuses. For example, the cylinders can be electrically or mechanically driven, and are not a limitation of the present invention.

Other possible modifications of the inventive spraying apparatus can include actuating means for several components, which can be actuated manually by an operator or can be totally automatic, being driven by sensors and actuators to map a tree and position the mechanism according to its shape.

It will be understood that each of the elements described above, or two or more together, may also find a useful application in other types of constructions differing from the types described above.

While the invention has been illustrated and described as embodied in a spraying apparatus for crops having unusually high trees, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A spraying apparatus for crops having unusually high trees, the spraying apparatus comprising means for producing a vertical flow of air with an agrochemical product; an air conduit having an inlet connected to a discharge of said flow producing means and also having an outlet; spraying means for producing a mist from the airflow with the agricultural product and spraying the mist to a tree, said air conduit being flexible and bellows-shaped; and means for extending and retracting said air conduit so that said air conduit can be extended and retracted according to a height of the tree and to position said spraying means at a corresponding height for spraying the mist to a desired target.

2. A spraying apparatus as defined in claim 1, wherein said flow generating means include an axial fan with a shaft in a vertical position, and means for driving said axial fan.

3. A spraying apparatus as defined in claim 2, wherein said means for driving said axial fan is means selected from the group consisting of a gear box and a hydraulic motor.

4. A spraying apparatus as defined in claim 1; and further comprising means for preventing a spinning tendency of a flow generated by said flow generating means.

5. A spraying apparatus as defined in claim 2; and further comprising for preventing a spinning tendency of the flow generated by said generating means, said preventing means including a plurality of fins positioned on top of said fan.

6. A spraying apparatus as defined in claim 1, wherein said means for extending and retracting include a telescopic lifting mechanism having several stages mounted to an upper end of said conduit to position said upper end of said conduit next to a target.

7. A spraying apparatus as defined in claim 1; and further comprising deflecting means coupled to an upper end of said air conduit for directing, accelerating and/or distributing the flow generated by said flow generating means to a desired target.

8. A spraying apparatus as defined in claim 1, wherein said spraying means include an element provided with a plurality of mist spraying nozzles.

9. A spraying apparatus as defined in claim 1, wherein said flexible bellows-shaped air conduit is provided with a plurality of circular rings along its length.

10. A spraying apparatus as defined in claim 9, wherein said circular rings are steel-belted rings which are seamed along the length of said air conduit.

11. A spraying apparatus as defined in claim 9; and further comprising elastic means arranged over said rings to form a bellows that allows said conduit to be extended or retracted.

12. A spraying apparatus as defined in claim 1, wherein said air conduit is composed of a fabric having a low weight to allow said air conduit to reach a height close to that of the trees.

13. A spraying apparatus as defined in claim 12, wherein said fabric is a silicone-coated polyester fabric.

14. A spraying apparatus as defined in claim 6, wherein said telescopic lifting mechanism includes a hydraulic cylinder and a plurality of telescopic frames each having a pulley system.

15. A spraying apparatus as defined in claim 14, wherein said hydraulic cylinder is a hydraulic cylinder having a short displacement and a plurality of telescopic frames each having a pulley system, so that said pulley system lifts an end of said lifting mechanism to a height of the tree through a multiplication provided by said pulley system.

16. A spraying apparatus as defined in claim 7, wherein said deflecting means is composed of a rigid plastic material.

17. A spraying apparatus as defined in claim 16, wherein said deflecting means is composed of polyethylene.

18. A spraying apparatus as defined in claim 16, wherein said deflecting means includes a plurality of deflectors having different shapes according to a type of crop to be sprayed.
